(19) United States
(12) Patent Application Publication
(10) Pub. No.: US 2008/0163335 A1
(43) Pub. Date: Jul. 3, 2008

(54) METHOD AND ARRANGEMENT FOR ROLE MANAGEMENT

(76) Inventor: Pekka Hagstrom, Helsinki (FI)

Correspondence Address: FASTH LAW OFFICES (ROLF FASTH), 26 PINECREST PLAZA, SUITE 2, SOUTHERN PINES, NC, 28387-4301, US

(21) Appl. No.: 11/962,881

(22) Filed: Dec. 21, 2007

(30) Foreign Application Priority Data
Dec. 28, 2006 (FI) 20061163

(51) Int. Cl. G06F 17/00

(52) U.S. Cl. 726/1

(57) ABSTRACT

The method and arrangement are for managing e.g. roles of a user in a network that has a plurality of application services provided for a plurality of stakeholders. The method grants permissions to a user in a role management system using representation objects. A representation object associates a stakeholder with a provider of at least one application service. The representation may then be associated with one or multiple users. The representation associated with the user may further be associated with at least one permission required to access the application service. The representation may reflect a contractual obligation between a user and a stakeholder and/or between a stakeholder and a service provider.

### PRIOR APPLICATION

This is a US national phase patent application that claims priority from Finnish patent application no. FI 20061163, filed 28 Dec. 2006.

### TECHNICAL FIELD OF INVENTION

The invention relates to a method and system for managing roles of users to access services provided by a computer system.

### BACKGROUND OF THE INVENTION

User access management is becoming an increasingly challenging task in corporate information technology systems as the systems grow larger and the number of system increases continuously. Knowing which users have which access rights to which applications, is becoming more and more vital piece of knowledge in organizations.

Initially, each application had its own authentication and authorization logic. The users had to have a separate userID and password for each system they need to use. The administration of user accounts of an application has typically been the responsibility of the “superuser” of the application who has access rights to the administrative functions of the application.

To improve the usability of the system, various methods for central authentication (single sign-on) have been introduced. One such method has been disclosed in U.S. patent application US20050240763—“Web based applications single sign on system and method”. The disclosure teaches a single sign-on system that includes logic for assigning and retrieving uniquely identifying tokens that are assigned to a user attempting to access one of many applications in the server. The token is assigned after the user has successfully logged into the server. The assigned token enables the user to access different applications in the server without having to authenticate every time the user goes from one application to the other.

Single sign-on provides significant improvement to the usability of the system. However, in a system that contains a number of applications, the administration of the user access rights may become an issue. Central administration of user data and security policies help solving this issue. The user role needed to use a service is typically expressed using declarative user authorization policy of a service. There are numerous patent publications that teach different methods and systems that use declarative policies for access control.

U.S. Patent Application US20060089938 discloses a method for distributed scalable policy based content management. A method for defining and constraining the behavior of a shared, mobile content management system is disclosed. The method includes providing an admin console for defining, modifying, and managing declarative policies. Declarative policies are defined based on an XML policy model. The XML policy model dictates the policies that can be expressed by the admin console.

U.S. patent application US20040083367 discloses a user authorization support method in computer system. The method involves initializing authorization policy store to maintain application associated with operation to be performed by user, for user authorization.

U.S. Patent Application US20040054663 discloses methods and apparatus for pre-filtered access control in computing systems. The publication teaches an automated technique implemented in a computer system for selecting one or more resources on which a principal is authorized to perform at least one action.

Patent Application WO06010707 discloses a generic declarative authorization scheme for Java. The publication discloses a method, system, and program storage device for establishing security and authorization policies for users accessing a software application, wherein the method comprises generating at least one application object group from an application object description document comprising an XML format run on a data processor. The method further comprises creating an authorization policy for each application object, sending a selected application object group to an access controller and establishing access control parameters at a time of deployment of the software application for users attempting to access the selected application object group based on the authorization policy.

U.S. Pat. No. 6,014,666 discloses declarative and programmatic access control of component-based server applications using roles. A programming model for component-based server applications provides declarative and programmatic access control at development without knowledge of the security configuration at deployment. The developer defines the server application access control by defining logical classes of users, called roles. The developer also can declare access privileges of the roles at package, component and interface levels of the server application. At development, the roles are bound to the particular security configuration of the server computer.

The declarative policies may be understood as business rules that may be created and maintained using a graphical tool such as a “wizard”. U.S. Patent U.S. Pat. No. 6,868,413 discloses systems and methods for customizing business logic rules within a business process automation system and for processing business logic rules in a business process automation system. The method comprises serving a content page to a client browser of a client by a server that allows entering and modifying of data relating to a business logic rule, generating data by the server according to a predefined format such as a predefined XML format from information received via the content page, and automatically committing the generated data in the predefined format into a database. A verification process such as by using DTDs (Document Type Definitions) is performed by the server prior to committing the data. The database stores data including data relating to business logic rules for implementing business logic as entries in the database and the generated data is committed into a corresponding entry in the database. Upon committing, the committed database business rule entry is ready for execution by the business logic application.

WO03001324 discloses a method to implement authorization services with external authentication e.g. for Internet based e-business, where the user's access to the resources is based on the identity profile associated with the user identification information.

EP1081576 discloses a computer system that can be used by a plurality of permitted users, each of whom can play at least one of a plurality of permitted roles, and can run a plurality of applications.

U.S. Pat. No. 6,985,955 discloses a system and method for provisioning resources to users based on roles, organizational information, attributes and third-party information or authorizations. The patent teaches a method for provisioning users with resources based on policies, roles, organizational information, attributes etc information from another user by determining which resource provisioning policies are applicable to user.

Although methods and systems of prior art disclose techniques for centralized management of business rules as well as centralized authentication and authorization services, they fail to address some significant problems of today's data communication networks that comprise plurality of independent systems accessed by plurality of users on behalf of a plurality of stakeholders. Solutions for providing flexible, manageable and scalable access management and control functionality in such network are thus needed.

### OBJECTS OF THE INVENTION

The object of the present invention is to provide a method and system for managing roles available to a user in a network comprising a plurality of services provided for a plurality of stakeholders from a plurality of service providers. Another object of the invention is to provide a method applicable for enabling externalization of user role management service from an individual organization and from an individual application service into a separate role management service that may manage user's roles and/or access authorization policies related to a plurality of organizations and/or plurality of application services. Yet another object of the invention is to provide a method for authorizing user's access to a service using centrally maintainable, possibly distributed, user data and authorization rules.

### SUMMARY OF THE INVENTION

The invention discloses a method and arrangement for managing e.g. roles of a user in a network comprising a plurality of application services provided for a plurality of stakeholders. The method grants permissions to a user in a role management system using representation objects. A representation object associates a stakeholder with a provider of at least one application service. The representation may then be associated with one or multiple users. The representation associated with the user may further be associated with at least one permission required to access the application service. The representation may reflect a contractual obligation between a user and a stakeholder and/or between a stakeholder and a service provider.

The invention further discloses a method and arrangement to authorize a user to access a service utilizing the association between user and stakeholder(s) that has been established by granting a representation to the user. The applications and services use access authorization logic (e.g. an access authorization policy) that may be externalized from the services of an application into an authorization policy document that is maintained by an access management system. The authorization logic of the policy document may utilize a data model maintained by the access management system. The data model may contain for example entities needed to describe organizational entities (stakeholders), users and dependencies between stakeholders and users (contracts, representations), available services and/or roles and other constraints that may be required by the services. Upon entering a contractual relationship with a stakeholder, the user may become a representative (i.e. may be granted a representation) of the stakeholder with some access rights defined in the access management system e.g. using permissions that may be applicable in the context of the representation

Each application (service) whose user access authorization is managed by the access management system specifies roles. In order to use a service, the user must for example through his/her representation(s) have a permission to a role that has been specified in the application. In the present invention, the roles of a user may be determined for example using the data model and data of the access management system. Roles available to a user are determined based on the contracts (representations) that have been granted to the user and various organizational entities (stakeholders).

In the present invention, having a permission to a required role is not necessarily enough for a user to use a service. The authorization logic maintained in the access management system may set additional service-specific and role-specific conditions that must be met before the service may be used. For example, user may be allowed to approve an invoice only if the invoice belongs to an organization unit that the approving user represents. Whether the user represents the organization unit or not, may be specified in the contract (i.e. representation) between user and organization unit (i.e. stakeholder). Further, the contract between the stakeholder and the user may specify additional conditions towards representative's usage of a service.

The system of the present invention may have a single sign-on authentication. When a person logs on to the system, the user ID and password (or some other means of authentication) are provided only once. Upon login, the system needs to determine, which representation (and thus, which roles and conditions related to the roles) of the user is in force in the session to be established. If there is only one representation available to the user, that representation may be automatically selected. If there are multiple representations, the proper one(s) for the session may be selected either automatically using e.g. some rules or manually. Thus, use of one user ID in the login process may result as different access rights depending on which stakeholder the user is representing through the selected representation. During the session, the person may also select further representations. Active representations may also be selected implicitly based on usage context, e.g. the services and data of the services being accessed by the user.

Based on e.g. the login information and/or usage context information a user session (also “session” and “user authorization session” in this document) is established for the user. The session may have means to provide information about which roles are available to the user based on e.g. the representation data of the access management system. In addition to list of roles, the session may have means to provide parameter data related to the user and/or session. For example, user of the session that has a representation (and through the representation, a permission associated with a role) required for approving an invoice on behalf of a stakeholder may have an upper limit to the value of the invoice he/she is allowed to approve. The upper limit may be specified by a parameter. The parameter may be for example user-specific or it may be specific to the representation. The parameter may for example be specified in the contract that is in force between the user and a stakeholder.

When the user of the system wants to use an application service, the service reads access authorization policy data that may be represented for example as content of an access authorization policy document of the service or by some other means. “Access authorization policy document” in this context means any means to store and/or represent data related to describing access rights requirements to one or multiple services, each of which may be represented in the access management system by at least one access object. At minimum, the access authorization policy document contains a list of roles containing at least one role. The user must have at least one of the roles listed in the access authorization document. To determine whether the user has any of the required roles, the service may query the user session information. The session may have the access information provisioned (i.e. cached locally) in an object containing session information or the object may query the information from the access management system. The cached data may reside e.g. in the deployment descriptors of a J2EE software resources. Representation data describing a contractual relationship between user and a stakeholder and the permissions associated with the representation may for example be used to determine whether user has a required role or not. Once a role has been found from the user session object, the application checks from the access authorization policy data whether there are additional conditions specified for that role. As mentioned above, one such condition could be that the approver of the invoice must represent the same organization unit whose invoice is being approved. The granted representation may be used for determining the relationship between user and an organization unit, for example. The granted representation may e.g. reflect rights and restrictions defined in a contract between the user and the stakeholder. In other words, the user needs to have a representation of a stakeholder granted to him/her in order to use the service and/or to access or modify data that is associated with a stakeholder. The authorization logic may also require that a value of a constraint parameter related to the user and specified through a granted representation is checked from the session data. The value of the constraint parameter may for example set the upper limit to the value of an invoice that the user may approve as a representative (i.e. as a person having been granted a representation) of a company (i.e. a stakeholder)

The access authorization policy document of a service may be updated e.g. by the access management system that maintains the access authorization policy data of the service. A copy of the document may be made available locally at the application whose service uses the document. The updated authorization policy may be made available for use immediately when updates are committed in the database of the central access management system. Alternatively, an event such as a date and time or system update may be specified to trigger the deployment of updated authorization logic.

In addition to containing instructions (e.g. roles and constraints) related to access authorization policy, the access authorization policy document of the present invention may also contain instructions about logging authorization-related events such as failed authorizations or events related to a specified user or user group. For example, the document may require that each usage attempt of a user must be logged if the session object of the user has a logging flag set on. In the system of the present invention, the authorization logging service is provided by the access management system.

The arrangement of the present invention may also comprise an authorization logic editor that provides graphical tools for defining the content of the access authorization documents.

The arrangement of the present invention may further comprise a repository of representation, role and other access management related data. The repository may be a distributed one. For example, there may be a copy of the master repository for each application whose access management is provided by the access management system of the invention.

The invention concerns a method for granting permissions to a user in a role management system, the method comprising steps of establishing a representation object to associate a stakeholder with a provider of at least one application service, associating the representation with the user, and specifying for the user, using the representation, at least one permission for accessing an application service provided by the provider of at least one application service.

The invention may further concern a method according wherein the user is authorized to execute the application service.

The permission specified for the user may be limited to the context of the representation.

The invention may yet further concern a method wherein the specifying of permission comprises a step of specifying at least one constraint for accessing the service. The constraint may specify a stakeholder and/or it may be a user-specific constraint.

The invention may still yet further concern a method wherein the authorization comprises steps of establishing an active user authorization session, the session providing means for determining at least one role associated with the user using data associated with the representation, reading authorization data of the service, the authorization data comprising at least one authorization policy comprising at least one role and at least one authorization constraint, determining at least one representation applicable to the user in the active user authorization session, determining availability of at least one required role for the user, the required role being specified in the authorization policy data, evaluating at least one authorization constraint related to the role and associated with the user, and determining the authorization status of the user to use the application service.

The invention may still yet further concern a method wherein the representation is determined upon sign-on.

The invention may still yet further concern a method wherein the representation is determined using data of said application service.

The invention may still yet further concern a method wherein a copy of said representation data and/or data related to the representation data and/or the application service is maintained in a second role management system for use of the application service.

Still yet further, the invention may concern a method wherein said authorization policy data is updated by said access management system and the updated authorization data is made available to said application service.

The invention may also concern a method wherein said authorization policy document comprises at least one instruction about producing logging data about the authorization event and/or authorized transaction.

The invention may also concern a method wherein said access management system translates at least one identifier representing said stakeholder or user into another identifier representing the same said stakeholder or user respectively.

The invention also concerns an arrangement that implements the method disclosed herein.

The best mode of the invention presently contemplated by the inventor applies the disclosure set forth herein to the management of access authorization data as well as performing authorization functions.

Some embodiments of the invention are described herein, and further applications and adaptations of the invention will be apparent to those of ordinary skill in the art.

### BRIEF DESCRIPTION OF THE DRAWINGS

In the following, the invention is described in greater detail with reference to the accompanying drawings in which

FIG. 1 shows an exemplary topology of the arrangement of an embodiment of the present invention,

FIG. 2 shows an exemplary object model of the access management system of an embodiment of the present invention,

FIG. 3 shows an exemplary authorization policy document of an embodiment of the present invention,

FIG. 4 shows an exemplary session object usable in an embodiment of the present invention,

FIG. 5 contains a flow chart illustrating exemplary high-level steps of authorizing a user to user a service according to an embodiment of the present invention, and

FIG. 6 contains a detailed flow chart illustrating exemplary steps needed to verify whether conditions of an authorization policy are met by the currently logged-on user according to an embodiment of the present invention.

### DETAILED DESCRIPTION

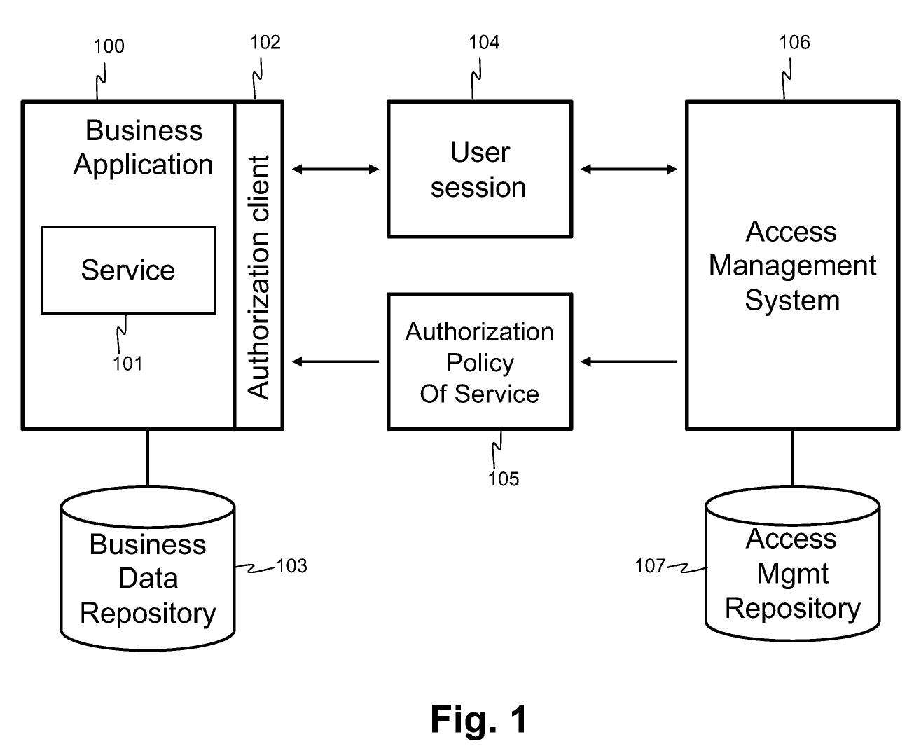

A high-level architecture diagram of an embodiment comprising a business application and an access management system is illustrated in FIG. 1. In an embodiment, there may be at least one (preferably multiple) business applications 100 each providing one or multiple application services 101. The business applications may be provided by one (preferably multiple) service providers. Each business application stores its application-specific data into one or multiple business data repositories 103. When a user of the system wants to access a service 101 of a business application 100, the system typically checks if the user is authorized to access the service. To do that, the service accesses through authorization client 101 the authorization policy of the service 105 and user-specific authorization data available through user session object 104. The authorization client may be implemented for example as a Java™ class package that is made available to the business application 100. The authorization policy data and user-specific authorization data of the business application(s) 100 are managed by the access management system 106 that advantageously stores the data in the access management repository 107. As shown in the figure, the management of access authorization data and policies is externalized from the business applications 100 to an access management system 106.

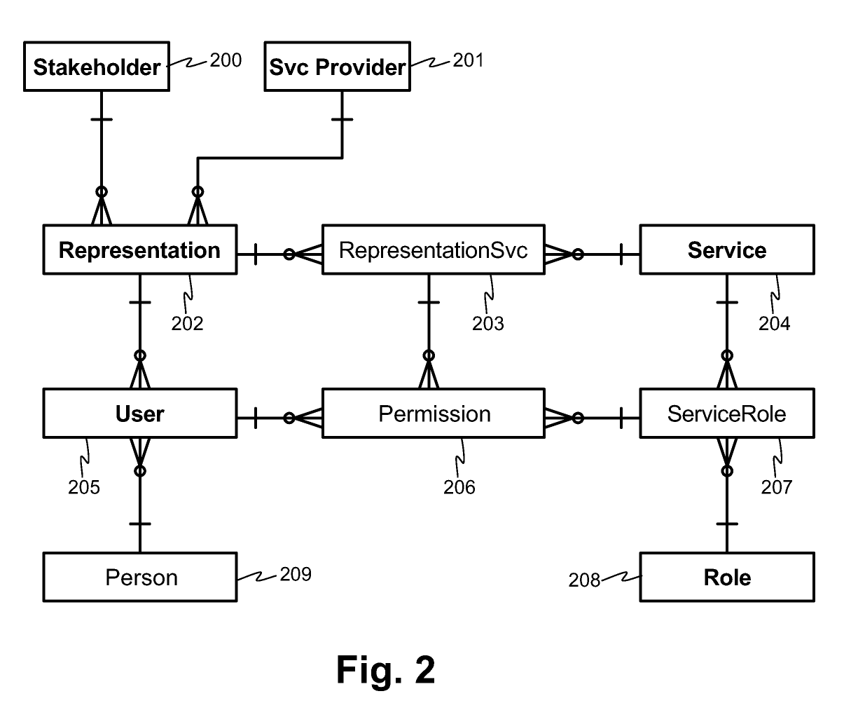

In some embodiments (not shown in figure), the access management system 106 may comprise a plurality of subsystems, e.g. an access management master (back-end) system and a plurality of access management front-end systems. The front-end systems may comprise a repository that contains e.g. a copy of a subset of the data of the master system. For example, there may be a separate front-end access management system for each individual application service provider operating one or multiple business applications in the network. The repository of the front-end system may contain only the data of those stakeholders and users who are associated with a service of the service provider through representations involving the particular service provider. Because the data model used by embodiments of the present invention (explained in more detail e.g. in FIG. 2) establishes an association between a service provider and stakeholders, it provides a convenient way to implement such distribution scheme for the role and access management data. This way, the scalability issue that is inherent to many role-based access control systems, can be avoided. For example data replication techniques known to a person skilled in the art may be used for maintaining the copies of data in the plurality of repositories.

FIG. 2 shows an exemplary object model of the access management system usable in an embodiment of the present invention. The data of the instances of the shown object model is managed by the access management repository (107 in FIG. 1).

User object 205 depicts a user (authorization) session of a person 209 logged into the system whose available roles and service access are controlled by the method of the present invention. When a person logs on to the system, he/she may select which stakeholder(s) he/she represents in the session. One or multiple representations 202 may be selected. In another embodiment, stakeholder(s) represented by the user is/are selected automatically based on the services and/or data of the services accessed by the user. For example, user may represent a borrower of a bond in an exemplary bond administration system. The user may further represent a stakeholder that is a guarantor of a number of bonds in the same exemplary system. The user of selected representation is associated with one or multiple permissions 206 on basis of the user and representation data. A permission 206 provides an access to a service 204 by associating the user with a role. The permission 206 is further associated with a Role 208 and a Service 204 through a ServiceRole object 207. A permission may for example allow the user to view data related to bonds in a bond administration system by permitting user to have access to a “bond viewer” role.

Stakeholder object 200 may for example depict a business organization, public authority, private person etc who constitutes an independent unit who possess juridical personality and is entitled to perform juridical acts. In access management context this may mean for example companies and private persons who deal with service providers as customers.

Service 204 represents e.g. a business application service (e.g. 101 in FIG. 1) whose access rights are managed by the method of an embodiment of the invention. The service may comprise at least one access object (not shown). A plurality of services 204 may be associated with a representation 202 using RepresentationSvc objects 203. These associated services are the services that may be accessed based on the representation 202.

Service provider object 201 may for example represent similar juridical unit as a stakeholder but in the access management context a service provider acts as supplier of applications and services 204 to stakeholders. Service provider grants the stakeholder 200 all the access rights to the system that are necessary for executing the services that service provider has agreed to provide to the stakeholder. The stakeholder may grant e.g. a subset of these rights further to users by granting representations of itself. The granting of representation may comprise specifying suitable access rights to users by means of granting permissions 206.

Representation object 202 establishes a relationship between a stakeholder and a service provider where the service provider acts as supplier of services and the stakeholder acts as a consumer of these services. A representation's authority is defined by those services which are associated with the representation. In the shown embodiment, this association may be done using the RepresentationSvc objects 203. In other words, representation object 202 associates together a stakeholder, a service provider, services available to the representation as well as users to whom the representation has been granted. Further, representation expresses the stakeholder's right to use the associated services and users' rights to represent a stakeholder. In an embodiment of the invention, the representation doesn't directly specify user's permissions to roles. Separate permission objects 206 may be used for specifying the actual access rights of the user when the user is acting as a representative of a stakeholder.

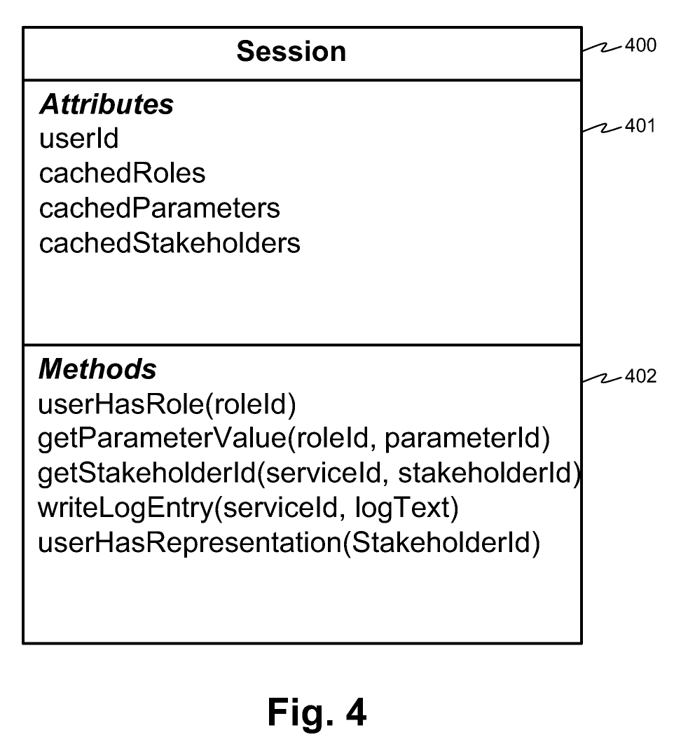

User object 205 (104 in FIG. 1, 400 in FIG. 4) may be understood as an agent for a stakeholder. The association between user and stakeholder is expressed using a representation object. A stakeholder may define representations of itself and each representation may be granted to a plurality of users. Typically, as part of the granting process, permissions related to the user and representation may be specified. In the shown embodiment, a user's authority to represent a stakeholder, in relation to a service provider, is defined by permission objects 206 associated with the user.

A role object 208 represents a job function e.g. within the context of an organization with some associated semantics regarding the authority and responsibility conferred on the user assigned to the role. Typically, a role is required from a user in order to use a particular application service. Permission object 206 represents a user's right to utilize an application service 204 in the name of the represented stakeholder. Permission is thus an association between a user and a role where representation object defines the operation context of the permission. In the present exemplary object model, authorization of a user 205 required to use a service 204 in the context of the representation 202 may for example be represented as a (collection of) permission object(s) 206. In order to execute a service, the conditions of at least one of the permissions related to the service must be met by the logged-on user. In the shown data model, permission is associated with at least one role 208 and optionally one or multiple additional conditions (not shown in picture).

The person object 209 may be used e.g. in an embodiment of the invention where a person may have multiple representations. In such embodiment, multiple user instances 205 may be instantiated, e.g. one instance for each representation usable by the person.

When a user logs on to the system, he/she may select which stakeholder(s) he/she represents in the session through the representations 202. For example, user may choose to represent a borrower who has some access rights to a bond administration system. For example, when using an exemplary bond administrator system, the user may represent his/her employer (stakeholder 200) that is a borrower (representation 202) of bonds. Additionally or alternatively, the representation may be selected automatically during the session e.g. on the basis of application service accessed or on basis of the data of the service being accessed. The access management system (106 in FIG. 1) may for example check from its repository (107 in FIG. 1) if the user has been granted a representation 202 of a stakeholder before granting access to the data of the stakeholder. The user of selected representation is associated with one or multiple permissions 206 on basis of the user 205 and representation 202 data. A permission 206 provides an access to a service based on limitations related to the permission 206, role 208 and/or service 204. A permission 206 may for example allow the user of the exemplary bond administration system to view bond data if the constraints related to the permission are satisfied. The constraint included in the permission may for example require that the user who wants to have view access to data of a bond must represent a stakeholder who is a guarantor, borrower or lender of the bond.

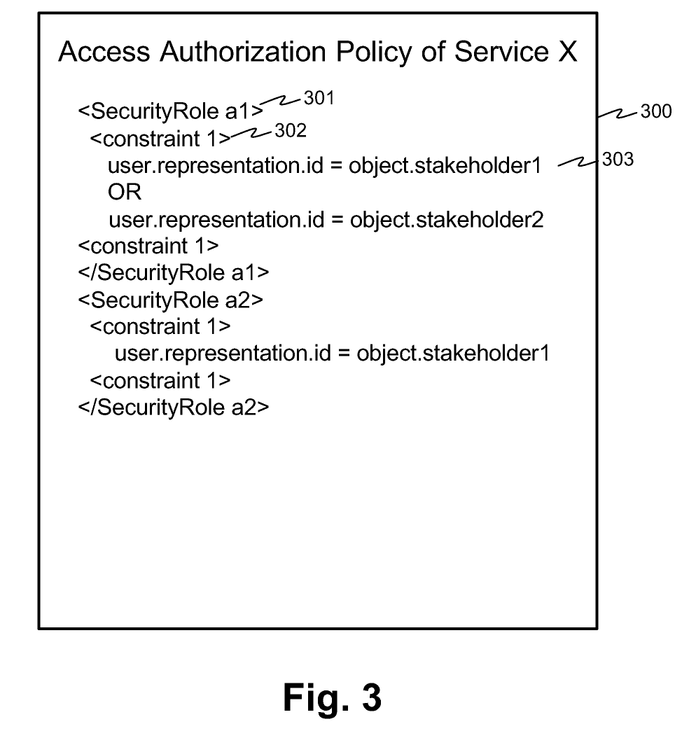

FIG. 3 shows an exemplary authorization policy for a service. In an embodiment of the present invention, each service of the system has its own authorization policy 300 that is maintained externally of the business application service, for example by the access management system 106. The policy may be defined and stored as an XML document in the access management repository 107, for example. At minimum, the policy may contain at least one role 301 (208 in FIG. 2) that the currently logged-on user must have in order to use the service. The role may have been made available to the user by granting the user at least one representation (202 in FIG. 2). Additional conditions (constraints) 302, 303 may be specified for each role. The logged-on user may need to represent a certain stakeholder in order to access or manipulate the data of the service, for example. In an exemplary case of a money transfer service of a banking system, the user needs to represent the stakeholder to whom the account belongs to or who otherwise has transfer rights for the account. The policy may also specify for example that a parameter value specific to the user is checked from the session data (104 in FIG. 1). Such parameter may for example specify the maximum amount that the user is allowed to withdraw from the account in a day under the specified role.

The following snippet of an exemplary XML document of an exemplary bond administration system further clarifies the use of roles and constraints in the embodiment explained herein:

```
<Role_bond_viewer>
  <context_constraint>
    this.representation.legalperson = bond.borrower
    OR
    this.representation.legalperson = bond.lender
    OR
    this.representation.legalperson = bond.guarantor
  </context_constraint>
</Role_bond_viewer>
```

In the above example, a role name “Role_bond_viewer” has a constraint that requires that the stakeholder represented by the user (this.representation.legalperson) must have a role of a borrower, lender or guarantor of the bond in order to have viewing rights to the bond. The constraint data may be stored for example in one or multiple instances (not shown) of a class related to Permission class 206 of the object model of FIG. 2. The value of “this.representation.legalperson” is determined by the access management system using e.g. the representation and other data of the present embodiment and the values of “bond.guarantor”, “bond.lender” and “bond.borrower” are determined by the application service that is being accessed. As shown in this embodiment, data maintained in a business application service (e.g. a bond administration system) is associated with data maintained by the access management system via role-specific constraints.

Constraints related to the permission to access a service may also contain user-specific limits. For example, a user may be allowed to administer bonds of a stakeholder whose total value is less than an amount specified for the user. For this purpose, in the exemplary embodiment shown, there is a role “Role_bond_administrator” defined that has two constraints.

```
<Role_bond_administrator>
  <context_constraint>
    this.representation.legalperson = bond.lender
      AND
    this.representation.legalperson.max_bond_value >
  bond.value
  </context_constraint>
</Role_bond_administrator>
```

According to the example shown above, in order to administer a bond, the user must have been granted a representation of a lender of the bond and the value of the bond must be less than the upper limit of the bond value specified for the user. The value of the “this.representation.legalperson.max_bond_value” parameter for the current user may be queried from the user authorization session information provided by the access management system. The session may have the information cached for example as a subject of an Enterprise Java Bean™ or it may query the repository (107 of FIG. 1) of the access management system for the information. The values of the “bond.lender” and “bond.value” parameters may be queried from the business data repository (103 of FIG. 1) of the system.

User session may be implemented for example as a user session object having attributes and methods. An exemplary user session object is illustrated in FIG. 4. The user session object 400 (104 in FIG. 1) of the shown embodiment is an entity in the system from which an application service (101 in FIG. 1) may query user-related information maintained e.g. by the access management system and that is needed to make the authorization decision based on the authorization logic specified in the authorization policies 300 (105 in FIG. 1) of the service. The session object of the shown embodiment provides means for querying user-specific authorization data from the access management system (106 in FIG. 1). The object may also act as a cache of the user-specific authorization data by storing in its own memory structures 401 data that has been queried from the access management system earlier using its methods 402. The exemplary methods available in the user session may include e.g. the following:
UserHasRole(roleID) may be called e.g. by the authorization client (102 in FIG. 1) when the client checks whether user has a role specified in the access authorization document 105. The method returns true if the user has the role specified by RoleID through the currently active representation (202 in FIG. 2) of the user.
GetParameterValue(roleId, parameterId) method returns a value for a parameter that may be for example specific to the current user and role.
GetStakeholderId(serviceId, stakeholderId) method returns an ID value for a stakeholder based on another ID of the same stakeholder. The returned ID is suitable for use by a service specified by the serviceId.
WriteLogEntry(serviceId, logText) method may be used to write a log entry for example to the repository of the access management system (107 in FIG. 1).
UserHasRepresentation(StakeholderId) method may return true (or the matching representation object(s)) if the user has at least one representation of the stakeholder identified by the StakeholderID parameter. This method may be used in embodiments where applicable representation is determined dynamically based on application data accessed by the user.

The user-specific authorization data 401 of the embodiment shown may comprise role information, stakeholder information and parameter data, for example. The stakeholder and parameter data may be associated with the role data. Typically, the stakeholder who has granted the role to the user through a representation is identified. Similarly, parameter data is typically related to a role and the value of the parameter for the user is determined in the representation. The session object may also provide logging services for the application services.

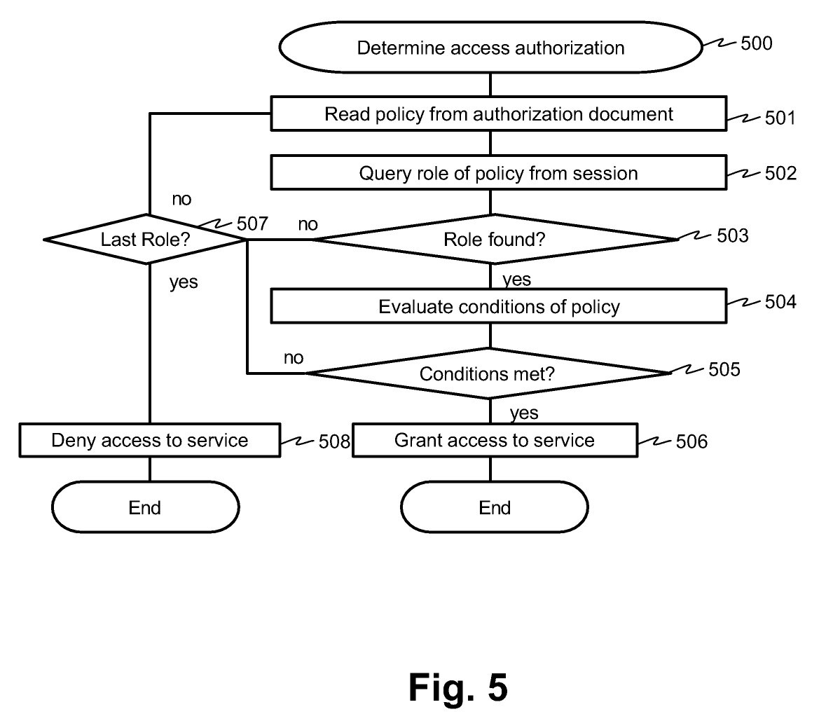

FIG. 5 shows at high-level a method of access authorization according to an embodiment of the present invention. When a logged-on user wants to execute a service, the service reads an authorization policy from the authorization document 501 using methods available to the service via authorization client (102 in FIG. 1). At minimum, there must be at least one policy associated with the service. The policy specifies at least one role that the logged-on user must possess for example through a representation. If no representation has been specified for the session, a possibly applicable representation may be queried as part of step 502. For example, if the user wants to view data of bond of a company X, the access management system may check which (if any) representation(s) the user has been granted by company X. The authorization client may then query from the session object whether the logged-on user has the required role or not through (any of) the representation(s) and associated permissions granted to the user. If the role is not reported 503 by the session object to be available to the user, the authorization client queries 502 another role of the same or another policy from the authorization document and checks 503 the existence of the role from session object. If none of the roles specified in the authorization policy document are found 507 from the user object, access to the service is denied 508. If a matching role is found, then the authorization client 102 proceeds to evaluating 504 the possible additional conditions specified in the policy and determines 505 based on the evaluation whether access should be granted or denied 506. Typically in the step of evaluation a condition, a data value from the access management system is compared with a data value available in the business application. If access is denied, then the authorization client 102 proceeds by checking next policy from the authorization document until the end of the document has been reached.

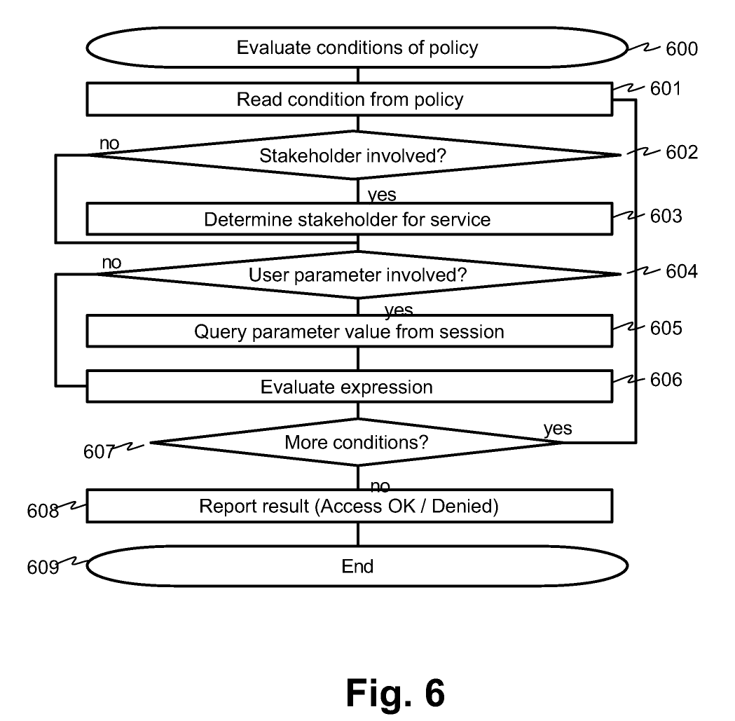

The step 504 (evaluate conditions of policy) of FIG. 5 is further explained in FIG. 6. At minimum, a policy contains a role that the user must have in order to access a service. However, in many cases, there may be additional conditions related to the role and/or to the user that must be met before access is granted. The authorization client (102 in FIG. 1) reads 601 from the authorization policy document (300 in FIG. 3) a condition (303 in FIG. 3) of a constraint (302 in FIG. 3) related to a role (301 in FIG. 3, 208 in FIG. 2). The authorization client may evaluate the condition based on data of the service object(s) of the business application and/or the authorization client may query data value(s) from the session information. For example, if the condition is related 602 to a stakeholder (200 in FIG. 2) e.g. a lender of a bond, the authorization client may query from the business application service who is the stakeholder (i.e. ID of a lender of a bond) that the user needs to represent in the role in question 603. If the condition (303 in FIG. 3) of a constraint (302 in FIG. 3) read in step 601 is related 604 to a user-specific parameter, the authorization client queries from the session information the value for the parameter 605. The parameter may for example be the ID of the legal entity (stakeholder) that the user represents. The correct answer (e.g. the ID of the stakeholder) to the query may depend on the application whose service is being executed. Different applications may have different IDs for the same stakeholder. For example, a business company may be identified by a generated (surrogate) key in one application whereas the same company may be identified by an ID provided by some authority such as Internal Revenue Service in the U.S. In an embodiment of the invention, the access management system provides a mapping service of stakeholder IDs. The mapping service may return based on one ID identifying the stakeholder another ID that identifies the same stakeholder in a specified application service. Similar mapping service may be made available also for translating user IDs between systems in embodiments where same person is identified with different userIDs in different business application systems.

Once the stakeholder ID and/or possible other parameter values have been resolved from the session object, the authorization client checks 606 if the provided ID and/or other parameter value matches with the data value specified in the object (e.g. a bond) of the application service (e.g. a bond administration service). In an exemplary bond administration service, the condition may require that the stakeholder ID represented by the logged-on user is the same as the ID of the lender specified in the bond. Alternatively or additionally, the condition may require for example that the maximum value of a bond specified for the logged-on user is not exceeded. Once all conditions of the policy have been evaluated 607, the authorization client (102 in FIG. 1) may conclude and report back to the business application service whether the user has been authorized to use the service or not based on the policy being checked.

To further illustrate advantages of the invention over prior art solutions, a following example is provided.

An asset manager (user of a wealth management system comprising stock trading system and derivatives trading system) has three customers (A, B and C) for whom the user may execute stock trading transactions and/or derivatives transactions. The wealth management system uses access control services of a separate access management system of an embodiment of the invention. The three customers of the user have been defined as stakeholders in the access management system. Each of the customers has made a contract with the asset manager. Two of the customers (A and B) have authorized the asset manager to perform stock transactions whereas the customer C has authorized the asset manager to execute both stock and derivatives transactions on behalf of the customer. These contracts are reflected in the access management system (that is external to the trading systems) so that customers A, B and C grant the asset manager a stock trading representation for the stock trading system. Additionally, customer C grants the asset manager a derivatives trading representation for the derivatives trading system.

When doing his daily trading work, the asset manager identifies an under-priced stock and wants to buy maximum allowed amount of the stock for each of his customers who have authorized him to do so. When executing the stock purchase transaction for each of the customers, the application service of the stock trading system queries from the access management system whether the user has been granted any representation that is associated with permission(s) required to perform such transaction on behalf of the three customers (who are stakeholders in the transactions) and what's the maximum amount of shares allowed in the transaction for each of the customers. Because of the permissions associated with the representations, the stock purchase transactions are allowed and maximum size of the transaction is provided by the access management system. For derivatives transactions (e.g. purchasing call options), suitable permissions are not found for customers A and B. Thus those transactions are denied and a call option purchase transaction is allowed only for customer C. As prior art solutions don't use the concept of representation, externalizing access control functionality of exemplary business applications as described herein into a separate access management system has not been practical or even possible.

The business application service may also use the data available in the access management service to identify data and services that the user is entitled to access through any representation granted to him. For example, as another aspect of the present example, the business application service may query access management service to return list of all stakeholders that the user has been entitled to represent (i.e. to whom the stakeholders have granted a representation) in the stock trading system. Based on the list of stakeholder IDs returned, the business application service may then retrieve and show the stock portfolio information of each of the stakeholders (i.e. customers A, B and C).

The embodiments of the present invention provide numerous advantages over prior art. For example, the use of a representation object as means of associating a stakeholder with a service provided by a service provider and granting of rights to a user by granting the representation to the user reflects the way how rights, duties and operating constraints are assigned in an organization. For example, the rights to execute a business transaction may be established by a contract between an individual and a stakeholder. Such contract may be reflected effectively in the present invention as a representation that has been granted to a user. Embodiments of the present invention also allow management of a federated identity, i.e. a single person may have different “personalities”, i.e. different access rights to the services of the network depending on which representation(s) the user is using in each usage context. Further, the present invention may allow providing of access control services to a plurality of stakeholders accessing a plurality of application services. The user needs to identify itself only once to the access management system to gain access to all those services that are allowed to the user on the basis of the representations and associated permissions granted to the user. Thus, access control services may be externalized from both stakeholders and application services. Yet further, the present invention may allow flexible reporting of access rights granted by a stakeholder as well as reporting of rights held by an individual user. Still yet further, the access management service may be made scalable e.g. through selective data replication where only the data related to a service provider through representation(s) is replicated e.g. to a front-end access management system that is dedicated to e.g. a specific service provider.

To a person skilled in the art, the foregoing exemplary embodiments illustrate the model presented in this application whereby it is possible to design different methods and arrangements, which in obvious ways to the expert, utilize the inventive idea presented in this application.

1. A method for granting permissions to a user in a role management system, comprising:
a. establishing a representation to associate a stakeholder with a provider of at least one application service,
b. associating the representation with the user, and
c. specifying for the user, using the representation, at least one permission for accessing an application service provided by the provider of at least one application service.

2. The method according to claim 1, wherein the user is authorized to execute the application service.

3. The method according to claim 1, wherein the specifying of permission for the user comprises specifying at least one user-specific constraint for accessing the service.

4. The method according to claim 2, wherein the authorization comprises:
establishing an active authorization session, the session providing means for determining at least one role associated with the user using data associated with the representation,
reading authorization policy data of the service, the authorization policy data comprising at least one authorization policy document comprising at least one role and at least one authorization constraint,
determining at least one representation available to the user in the active authorization session,
determining availability of at least one required role for the user, the required role being specified in the policy data obtained from the authorization data,
evaluating at least one authorization constraint related to the role and associated with the user, and determining the authorization status of the user to use the application service.

5. The method according to claim 4, wherein the representation is determined upon sign-on.

6. The method according to claim 4, wherein the representation is determined using data of the application service.

7. The method according to claim 1, wherein a copy of the representation data related to the application service is maintained in a second role management system for use of the application service.

8. The method according to claim 4, wherein the authorization policy document comprises at least one instruction about producing logging data about the authorization event and/or authorized transaction.

9. The method according to claim 4, wherein the evaluating step comprises querying a first data value from the access management system and querying a second data value from the application service.

10. The method according to claim 4, wherein the evaluating step further comprises performing at least one logical comparison operation between data value provided by the application service and data value provided by the access management system.

11. The method according to claim 4, wherein the authorization policy data is updated by the access management system and data of the updated document is made available to the application service.

12. The method according to claim 4, wherein the access management system translates at least one identifier representing the stakeholder or user into another identifier representing the stakeholder or user respectively.

13. An arrangement for granting permissions to a user in a role management system, comprising:
means for establishing a representation to associate a stakeholder with a provider of at least one application service,
means for associating the representation with the user, and
means for specifying for the user, using the representation, at least one permission for accessing an application service provided by the provider of at least one application service.

14. The arrangement according to claim 13, wherein the arrangement further comprises means for authorizing a user to execute the application service.

15. The arrangement according to claim 13, wherein the means for specifying a permission comprises means for specifying at least one user-specific constraint for accessing the service.

16. The arrangement according to claim 14, wherein the authorization means further comprises:
means for establishing an active authorization session, the session providing means for determining at least one role associated with the user using data associated with the representation,
means for reading authorization policy data of the service, the authorization policy data comprising at least one authorization policy document comprising at least one role and at least one authorization constraint,
means for determining at least one representation available to the user in the active authorization session,
means for determining availability of at least one required role for the user, the required role being specified in the policy data obtained from the authorization data,
means for evaluating at least one authorization constraint related to the role and associated with the user, and
means for determining the authorization status of the user to use the application service.

17. The arrangement according to claim 16, wherein the arrangement further comprises means for determining the representation upon sign-on.

18. The arrangement according to claim 16, wherein the arrangement further comprises means for determining the representation using data of the application service.

19. The arrangement according to claim 13, wherein the arrangement further comprises means for maintaining a copy of the representation data related to the application service in a second role management system for use of the application service.

20. The arrangement according to claim 16, wherein the authorization policy document comprises at least one instruction about producing logging data about the authorization event and/or authorized transaction.

21. The arrangement according to claim 16, wherein the evaluating means further comprises means for querying a first data value from the access management system and means for querying a second data value from application service.

22. The arrangement according to claim 16, wherein the evaluating means further comprises means for performing at least one logical comparison operation between data value provided by the application service and data value provided by the access management system.

23. The arrangement according to claim 16, wherein the access management system comprises means for updating the authorization policy data and means for making data of the updated document available to the application service.

24. The arrangement according to claim 16, wherein the access management system comprises means for translating at least one identifier representing the stakeholder or user into another identifier representing the stakeholder or user respectively.
